(19) United States
(12) Patent Application Publication
(10) Pub. No.: US 2017/0253735 A1
(43) Pub. Date: Sep. 7, 2017

(54) HALOGEN-FREE AND FLAME RETARDANT COMPOSITIONS WITH LOW THERMAL EXPANSION FOR HIGH DENSITY PRINTED WIRING BOARDS

(71) Applicant: BLUE CUBE IP LLC, Midland, MI (US)

(72) Inventors: Xiaomei SONG, Shanghai (CN); Hongyu CHEN, Shanghai (CN); Michael MULLINS, Houston, TX (US)

(21) Appl. No.: 15/505,497

(22) PCT Filed: Aug. 25, 2015
(86) PCT No.: PCT/US2015/046752

§ 371 Date: Feb. 21, 2017

(30) Foreign Application Priority Data
Aug. 29, 2014 (CN) PCT/CN2014/085581

(51) Int. Cl. C08L 63/04; B32B 15/092; C08G 59/62; C08L 61/14; C08G 59/24; C08G 59/32

(52) U.S. Cl. CPC C08L 63/04; C08G 59/24; C08G 59/245; C08G 59/3218; C08G 59/621; C08L 61/14; B32B 15/092

(57) ABSTRACT

A multifunctional naphthol-based epoxy resin composition which is a reaction product of a) a naphthol which is a reaction product of i) from 1 to 99 weight percent 1-naphthol and ii) from 1 to 99 weight percent 2-naphthol; and b) an epihalohydrin, is disclosed. Also disclosed is a curable composition comprising: a) an epoxy component comprising the multifunctional naphthol-based epoxy resin composition; and b) a hardener component comprising i) a phenolic resin component selected from the group consisting of phenol novolac resins, triphenolalkane phenolic resins, aralkyl phenolic resins, biphenyl phenolic resin, biphenyl aralkyl phenolic resins, substituted naphthalene phenolic resins unsubstituted naphthalene phenolic resins, and combinations thereof; and ii) a phosphorus-containing composition which is the reaction product of an etherified resole with 9,10-dihydro-9-oxa-10-phosphaphenanthrene-10-oxide (DOPO). The curable composition can be used to prepare prepregs, electrical laminates, printed circuit boards, and printed wiring boards.

### FIELD OF THE INVENTION

The present invention is related to epoxy resin compositions. More particularly, the present invention is related to halogen-free or substantially halogen-free formulations.

### INTRODUCTION

Epoxy resins are widely used in coatings, adhesives, printed circuit boards, semiconductor encapsulants, adhesives and aerospace composites thanks to the excellent mechanical strength;

chemical, moisture, and corrosion resistance; good thermal, adhesive, and electrical properties.

The integrated circuit and printed circuit board industries are in need of low cost, highly reliable interconnect schemes that support the rapidly increasing input/output (I/O) count in ASICs and microprocessors. There is a growing interest in alternatives to the standard ceramic chip in conventional printed circuit boards for single and multichip carrier applications. However, the mismatch of the coefficient of thermal expansion (CTE) between printed wiring boards (PWB) base materials in the x-axis and y-axis in a plane and silicon leads to stress between components and the PWB. The stress is released mainly by deformation of the solder ball and the PWB. On the other hand, the mismatch of the CTE between PWB base materials in z-axis and copper leads to a failure of the board, although the mechanism is different. Copper plated-through holes (PTH) and copper plate vias will suffer cracks within the copper due to the substantially higher expansion of the PWB. Thus, a composition having a lower CTE in x- and y-axis towards silicon and in z-axis towards copper resulting in lower stress between the PWB and its components, is desirable.

### SUMMARY

In one embodiment, the instant invention provides a multifunctional naphthol-based epoxy resin composition.

In another alternative embodiment, the instant invention provides a multifunctional naphthol-based epoxy resin composition which is a reaction product of a) a naphthol novolac which is a reaction product of i) from 1 to 99 weight percent 1-naphthol and ii) from 1 to 99 weight percent 2-naphthol; and b) an epihalohydrin.

In another alternative embodiment, the instant invention further provides a curable composition comprising: a) an epoxy component comprising a multifunctional naphthol-based epoxy resin composition; and b) a hardener component comprising i) a phenolic resin component selected from the group consisting of phenol novolac resins, triphenolalkane phenolic resins, aralkyl phenolic resins, biphenyl phenolic resin, biphenyl aralkyl phenolic resins, substituted naphthalene phenolic resins unsubstituted naphthalene phenolic resins, and combinations thereof; and ii) a phosphorus-containing composition which is the reaction product of an etherified resole with 9,10-dihydro-9-oxa-10-phosphaphenanthrene-10-oxide.

In an alternative embodiment, the instant invention provides a prepreg, an electrical laminate, a printed circuit board, and a printed wiring board prepared from the curable composition.

### DETAILED DESCRIPTION

The instant invention is a composition. The instant invention is a multifunctional naphthol-based epoxy resin. The instant invention is also a curable composition. The instant invention is a curable composition comprising, consisting of, or consisting essentially of an epoxy component comprising a multifunctional naphthol-based epoxy resin composition and a hardener component comprising i) a phenolic resin selected from the group consisting of phenol novolac resins, triphenolalkane phenolic resins, aralkyl phenolic resins, biphenyl phenolic resin, biphenyl aralkyl phenolic resins, substituted naphthalene phenolic resins unsubstituted naphthalene phenolic resins, and combinations thereof; and ii) a phosphorus-containing composition which is the reaction product of an etherified resole with 9,10-dihydro-9-oxa-10-phosphaphenanthrene-10-oxide.

The curable composition can further include optionally a filler. The curable composition can further include optionally a catalyst and/or a solvent.

The curable composition may further include one or more fillers selected from the group consisting of natural silica, fused silica, alumina, hydrated alumina, talc, alumina trihydrate, magnesium hydroxide and combinations thereof. The curable composition may comprise 10 to 80 percent by weight of one or more fillers. All individual values and subranges from 10 to 80 weight percent are included herein and disclosed herein, for example, the weight percent of filler can be from a lower limit of 10, 12, 15, 20, or 25 weight percent to an upper limit of 62, 65, 70, 75, or 80 weight percent. For example, curable composition may comprise 15 to 75 percent by weight of one or more fillers; or in the alternative, curable composition may comprise 20 to 70 percent by weight of one or more fillers. Such fillers include, but are not limited to natural silica, fused silica, alumina, hydrated alumina, talc, alumina trihydrate, magnesium hydroxide and combinations thereof.

The curable composition may further include one or more catalysts. The curable composition may comprise 0.01 to 10 percent by weight of one or more catalysts. All individual values and subranges from 0.01 to 10 weight percent are included herein and disclosed herein, for example, the weight percent of catalyst can be from a lower limit of 0.01, 0.03, 0.05, 0.07, or 1 weight percent to an upper limit of 2, 3, 4, 6, or 10 weight percent. For example, curable composition may comprise 0.05 to 10 percent by weight of one or more catalysts; or in the alternative, curable composition may comprise 0.05 to 2 percent by weight of one or more catalysts. Such catalysts include, but are not limited to 2-methyl imidazole (2MI), 2-phenyl imidazole (2PI), 2-ethyl-4-methyl imidazole (2E4MI), 1-benzyl-2-phenylimidazole (1B2PZ), boric acid, triphenylphosphine (TPP), tetraphenylphosphonium-tetraphenylborate (TPP-k), and combinations thereof.

The curable composition may further include one or more tougheners. The curable composition may comprise 0.01 to 70 percent by weight of one or more tougheners. All individual values and subranges from 0.01 to 70 weight percent are included herein and disclosed herein, for example, the weight percent of toughener can be from a lower limit of 0.01, 0.05, 1, 1.5, or 2 weight percent to an upper limit of 15, 30, 50, 60, or 70 weight percent. For example, curable composition may comprise 1 to 50 percent by weight of one or more tougheners; or in the alternative, curable composition may comprise 2 to 30 percent by weight of one or more tougheners.

Such tougheners include, but are not limited to core shell rubbers. A core shell rubber is a polymer comprising a rubber particle core formed by a polymer comprising an elastomeric or rubbery polymer as a main ingredient and a shell layer formed by a polymer graft polymerized on the core. The shell layer partially or entirely covers the surface of the rubber particle core by graft polymerizing a monomer to the core. Generally the rubber particle core is constituted from acrylic or methacrylic acid ester monomers or diene (conjugated diene) monomers or vinyl monomers or siloxane type monomers and combinations thereof. The toughening agent may be selected from commercially available products; for example, Paraloid EXL 2650A, EXL 2655, EXL2691 A, each available from The Dow Chemical Company, or Kane Ace® MX series from Kaneka Corporation, such as MX 120, MX 125, MX 130, MX 136, MX 551, or METABLEN SX-006 available from Mitsubishi Rayon.

The curable composition may further include one or more solvents. The curable composition may comprise 0.01 to 50 percent by weight of one or more solvents. All individual values and subranges from 0.01 to 50 weight percent are included herein and disclosed herein, for example, the weight percent of solvent can be from a lower limit of 0.01, 0.03, 0.05, 0.07, or 1 weight percent to an upper limit of 2, 6, 10, 15, or 50 weight percent. For example, curable composition may comprise 1 to 50 percent by weight of one or more solvents; or in the alternative, curable composition may comprise 2 to 30 percent by weight of one or more solvents. Such solvents include, but are not limited to methyl ethyl ketone (MEK), toluene, xylene, cyclohexanone, dimethylformamide (DMF), ethyl alcohol (EtOH), propylene glycol methyl ether (PM), propylene glycol methyl ether acetate (DOWANOL™ PMA) and combinations thereof.

In various embodiments, the multifunctional naphthol based epoxy resin composition is an epoxidized naphthol novolac. An example of the epoxy composition is depicted in Formula 1.

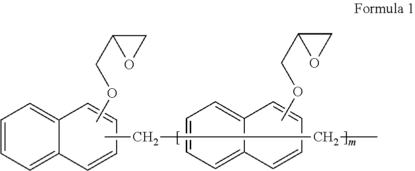

In Formula 1, m is an integer between 1 and 10. All individual values and subranges from 1 to 10 are included herein and disclosed herein, for example m can be 1, 2, 3, 4, 5, 6, 7, 8, 9, or 10.

In various embodiments, the epoxy component is formed by first synthesizing a naphthol novolac (mNPN). In various embodiments, a naphthol component is contacted with an aldehyde to form the naphthol novolac. An example of the reaction scheme is depicted in Formula 2, below.

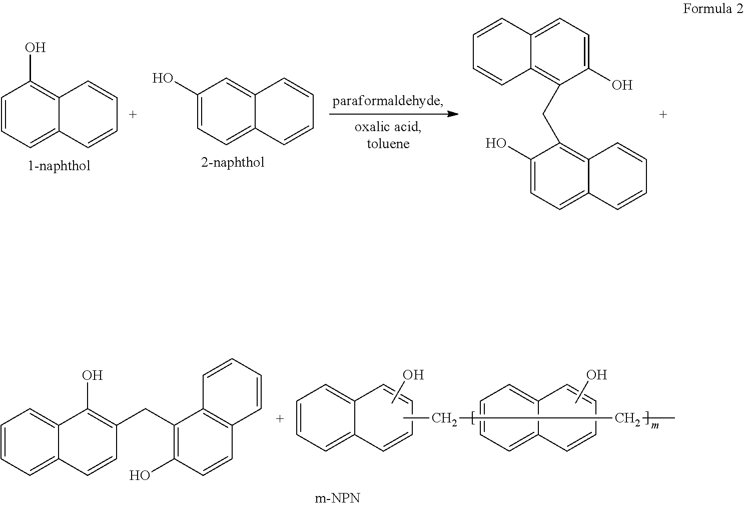

The naphthol novolac is a reaction product of I) from 1 to 99 weight percent 1-naphthol and II) from 1 to 99 weight percent 2-naphthol. All individual values and subranges from 1 to 99 weight percent are included herein and disclosed herein, for example, the weight percent of 1-naphthol can be from a lower limit of 1, 10, 14, 33, 50, 66, 71, or 80 weight percent to an upper limit of 25, 33, 55, 66, 82, or 95 weight percent. Likewise, the weight percent of 2-naphthol can be from a lower limit of 1, 10, 14, 33, 50, 66, 71, or 80 weight percent to an upper limit of 25, 33, 55, 66, 82, or 95 weight percent.

In various embodiments, paraformaldehyde can be used as the aldehyde. Other aldehydes that can be used include, but are not limited to formaldehyde, aliphatic aldehydes, and aromatic aldehydes.

In various embodiments, the naphthol component can be added to a solvent before contact with the aldehyde. Any suitable solvent can be used such as, for example, toluene and xylene.

The naphthol novolac composition can then be contacted with an epihalohydrin to form an epoxidized naphthol novolac. In various embodiments, the epihalohydrin is epichlorohydrin (EPI). One example of the reaction scheme is depicted in Formula 3, below.

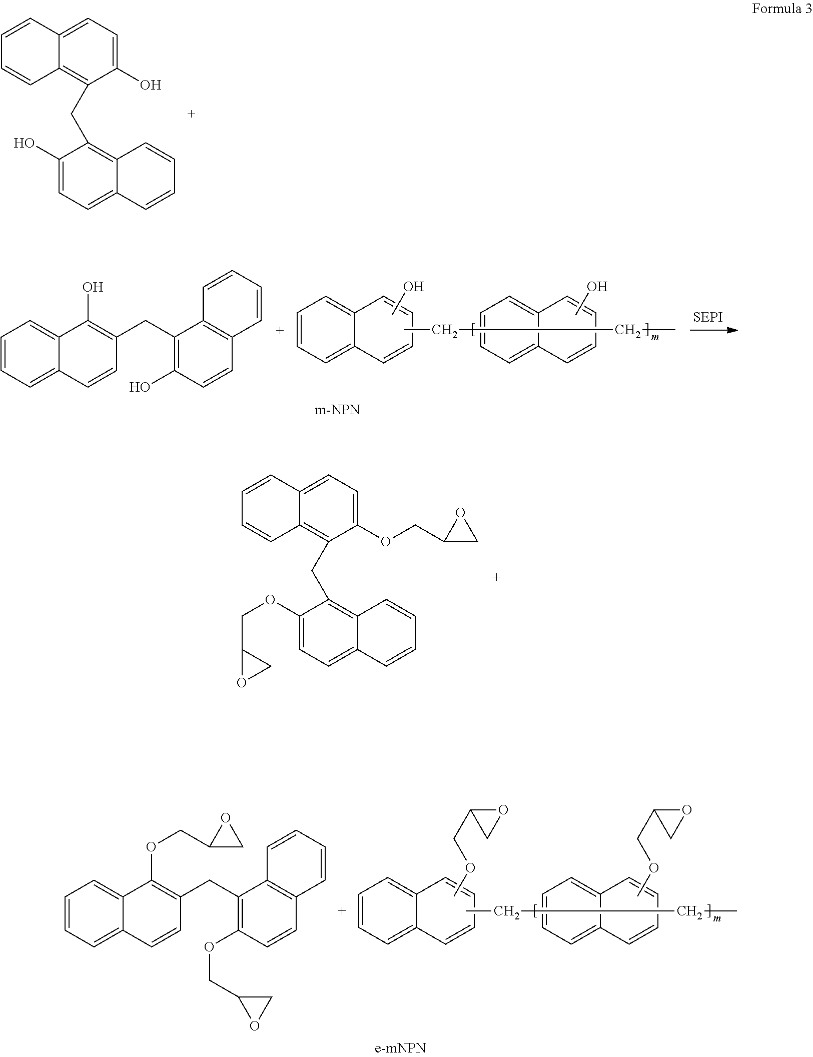

The curable composition comprises a) an epoxy component comprising the above multifunctional naphthol based epoxy resin composition; b) a phenolic resin comprising a molecule having at least one substituted or unsubstituted naphthalene ring; and c) an oligomeric compound curing agent comprising a phosphorus composition which is the reaction product of an etherified resole with 9,10-dihydro-9-oxa-10-phosphaphenanthrene-10-oxide.

The curable composition may comprise 1 to 99 percent by weight of the epoxy component. All individual values and subranges from 1 to 99 weight percent are included herein and disclosed herein, for example, the weight percent of epoxy resin can be from a lower limit of 12, 17, 20, 30, or 35 weight percent to an upper limit of 55, 70, 86, 90, or 98 weight percent. For example, curable composition may comprise 20 to 98 percent by weight of one or more epoxy resins or in the alternative, curable composition may comprise 30 to 90 percent by weight of one or more epoxy resins.

The curable composition may comprise 1 to 99 percent by weight of one or more phenolic resins. In an embodiment, the phenolic resin is a naphthalene type phenolic resin. Such phenolic resins ensure that the epoxy resin composition in the cured state has a low coefficient of linear expansion and a high Tg in a temperature range from room temperature to equal to or above Tg. All individual values and subranges from 1 to 99 weight percent are included herein and disclosed herein, for example, the weight percent of phenolic resin can be from a lower limit of 1, 1.2, 1.5, 12, or 20 weight percent to an upper limit of 45, 50, 54, 60, or 70 weight percent.

Phenolic resins that can be used include, but are not limited to novolac type phenolic resins (e.g., phenol novolac resins, cresol novolac resins), triphenolalkane type phenolic resins (e.g., triphenolmethane phenolic resins, triphenolpropane phenolic resins), phenol aralkyl type phenolic resins, biphenyl aralkyl type phenolic resins, biphenyl type phenolic resins. In an embodiment, the phenolic resin is a naphthalene type phenolic resin. These phenolic resins may be employed alone or in combination of two or more.

The curable composition may comprise 1 to 80 percent by weight of one or more oligomeric compounds comprising a phosphorus composition which is the reaction product of an etherified resole with DOPO. Such DOPO containing resins can be selected from DOPO-BN, DOPO-HQ, and/or other reactive or non-reactive DOPO-containing resins. All individual values and subranges from 1 to 80 weight percent are included herein and disclosed herein, for example, the weight percent of

DOPO compound can be from a lower limit of 1.5, 2, 3, 5, or 10 weight percent to an upper limit of 20, 40, 55, 60, or 70 weight percent. For example, curable composition may comprise 1 to 60 percent by weight of one or more DOPO compound or in the alternative, curable composition may comprise 5 to 40 percent by weight of one or more DOPO compound.

In an embodiment, the DOPO-containing compound is an oligomeric composition comprising a phosphorus-containing compound which is the reaction product of an etherified resole with 9, 10-dihydro-9-oxa-10-phosphaphenanthrene-10-oxide (DOPO). This reaction product is depicted in Formula 4, below.

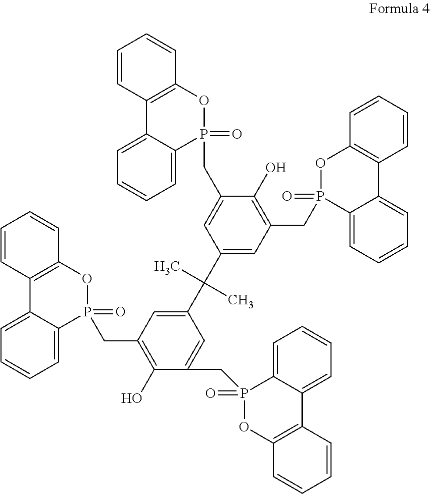 [SMILES: CC(C)(c1cc(CP2(=O)Oc3ccccc3-c3ccccc32)c(O)c(CP2(=O)Oc3ccccc3-c3ccccc32)c1)c1cc(CP2(=O)Oc3ccccc3-c3ccccc32)c(O)c(CP2(=O)Oc3ccccc3-c3ccccc32)c1]

Further information about this composition and its preparation can be found in U.S. Pat. No. 8,124,716.

In one or more embodiments, the curable composition can contain a solvent. Solvents can be used to solubilize the epoxy and hardener component or to adjust the viscosity of the final varnish. Examples of solvents that can be used include, but are not limited to methanol, acetone, n-butanol, methyl ethyl ketone (MEK), cyclohexanone, benzene, toluene, xylene, dimethylformamide (DMF), ethyl alcohol (EtOH), propylene glycol methyl ether (PM), propylene glycol methyl ether acetate (DOWANOL™ PMA) and mixtures thereof.

The composition can be produced by any suitable process known to those skilled in the art. In an embodiment, the epoxy component is prepared as described above. Solutions of the epoxy component, resin, and phosphorus-containing composition are then mixed together. Any other desired component, such as the optional components described above, are then added to the mixture.

Embodiments of the present disclosure provide prepregs that includes a reinforcement component and the curable composition, as discussed herein. The prepreg can be obtained by a process that includes impregnating a matrix component into the reinforcement component. The matrix component surrounds and/or supports the reinforcement component. The disclosed curable compositions can be used for the matrix component. The matrix component and the reinforcement component of the prepreg provide a synergism. This synergism provides that the prepregs and/or products obtained by curing the prepregs have mechanical and/or physical properties that are unattainable with only the individual components. The prepregs can be used to make electrical laminates for printed circuit boards.

The reinforcement component can be a fiber. Examples of fibers include, but are not limited to, glass, aramid, carbon, polyester, polyethylene, quartz, metal, ceramic, biomass, and combinations thereof. The fibers can be coated. An example of a fiber coating includes, but is not limited to, boron.

Examples of glass fibers include, but are not limited to, A-glass fibers, E-glass fibers, C-glass fibers, R-glass fibers, S-glass fibers, T-glass fibers, and combinations thereof. Aramids are organic polymers, examples of which include, but are not limited to, Kevlar®, Twaron®, and combinations thereof. Examples of carbon fibers include, but are not limited to, those fibers formed from polyacrylonitrile, pitch, rayon, cellulose, and combinations thereof. Examples of metal fibers include, but are not limited to, stainless steel, chromium, nickel, platinum, titanium, copper, aluminum, beryllium, tungsten, and combinations thereof. Examples of ceramic fibers include, but are not limited to, those fibers formed from aluminum oxide, silicon dioxide, zirconium dioxide, silicon nitride, silicon carbide, boron carbide, boron nitride, silicon boride, and combinations thereof. Examples of biomass fibers include, but are not limited to, those fibers formed from wood, non-wood, and combinations thereof.

The reinforcement component can be a fabric. The fabric can be formed from the fiber, as discussed herein. Examples of fabrics include, but are not limited to, stitched fabrics, woven fabrics, and combinations thereof. The fabric can be unidirectional, multiaxial, and combinations thereof. The reinforcement component can be a combination of the fiber and the fabric.

The prepreg is obtainable by impregnating the matrix component into the reinforcement component. Impregnating the matrix component into the reinforcement component may be accomplished by a variety of processes. The prepreg can be formed by contacting the reinforcement component and the matrix component via rolling, dipping, spraying, or other such procedures. After the prepreg reinforcement component has been contacted with the prepreg matrix component, the solvent can be removed via volatilization. While and/or after the solvent is volatilized the prepreg matrix component can be cured, e.g. partially cured. This volatilization of the solvent and/or the partial curing can be referred to as B-staging. The B-staged product can be referred to as the prepreg.

For some applications, B-staging can occur via an exposure to a temperature of 60° C. to 250° C.; for example B-staging can occur via an exposure to a temperature from 65° C. to 240° C., or 70° C. to 230° C. For some applications, B-staging can occur for a period of time of 1 minute (min) to 60 min; for example B-staging can occur for a period of time from, 2 min to 50 min, or 5 min to 40 min. However, for some applications the B-staging can occur at another temperature and/or another period of time.

One or more of the prepregs may be cured (e.g. more fully cured) to obtain a cured product. The prepregs can be layered and/or formed into a shape before being cured further. For some applications (e.g. when an electrical laminate is being produced) layers of the prepreg can be alternated with layers of a conductive material. An example of the conductive material includes, but is not limited to, copper foil. The prepreg layers can then be exposed to conditions so that the matrix component becomes more fully cured.

One example of a process for obtaining the more fully cured product is pressing. One or more prepregs may be placed into a press where it subjected to a curing force for a predetermined curing time interval to obtain the more fully cured product. The press has a curing temperature in the curing temperature ranges stated above. For one or more embodiments, the press has a curing temperature that is ramped from a lower curing temperature to a higher curing temperature over a ramp time interval.

During the pressing, the one or more prepregs can be subjected to a curing force via the press. The curing force may have a value that is 10 kilopascals (kPa) to 350 kPa; for example the curing force may have a value that is 20 kPa to 300 kPa, or 30 kPa to 275 kPa. The predetermined curing time interval may have a value that is 5 s to 500 s; for example the predetermined curing time interval may have a value that is 25 s to 540 s, or 45 s to 520 s. For other processes for obtaining the cured product other curing temperatures, curing force values, and/or predetermined curing time intervals are possible. Additionally, the process may be repeated to further cure the prepreg and obtain the cured product.

The prepregs can be used to make composites, electrical laminates, and coatings. Printed circuit boards prepared from the electrical laminates can be used for a variety of applications. In an embodiment, the printed circuit boards are used in smartphones and tablets. In various embodiments, the electrical laminates have a copper peel strength in the range of from 4 lb/in to 12 lb/in.

### EXAMPLES

Synthesis of Naphthol Novolac Hardener (mNPN)

All materials used in synthesizing naphthol novolacs were Sinopharm Co. (Shanghai, China) except as mentioned otherwise.

1-Naphthol (24g, 0.17mol) and 2-naphthol (12 g, 0.083 mol) were dissolved in toluene (75 ml) at 50° C. (using a 250 ml 3-neck round bottom flask equipped with a stirrer, condenser and a tube for introduction of N₂). After the solids disappeared, oxalic acid (300 mg, 5 mmol) was added followed by paraformaldehyde (6.75 g, 0.225 mol). The reaction mixture was slowly heated to 90° C. and lots of bubbles appeared. After it was calmed down, the mixture was refluxed with stirring for 6.5 hours. Then it was cooled to 50° C. and the upper toluene solution was removed. The residue was then dissolved with cyclohexanone (30 ml) at 80° C. for 1 hour. The solution could be used without further purification. A small portion was removed and dried at 80° C. in a vacuum oven for 3 hours to calculate the concentration of mNPN in cyclohexanone.

Naphthol novolacs with lower molecular weight were synthesized similarly by adjusting the ratio of 1-naphthol and 2-naphthol. The mNPNs were characterized by Gel Permeation Chromatography (GPC) according to the settings in Table 1. The mNPNs with different functionalities that were used are shown in Table 2.

TABLE 1
Gel Permeation Chromatography (GPC)

| | |
|---|---|
| Instrument | Agilent 1200 |
| Columns | Two Mixed E columns (7.8 × 300 mm) in tandem. |
| Column | 40° C. |
| Temperature | |
| Mobile Phase | Tetrahydrofuran |
| Flow | 1.0 ml/min |
| Injection | 50 μl |
| volume | |
| Detector | Agilent Refractive Index detector, 40° C. |
| Software | Agilent GPC software. Data was collected from |
| | duplicate injections. |
| Calibration | PL Polystyrene Narrow standards (Part No.: 2010-0101) |
| Curve | with molecular weights ranging from 19,760 to |
| | 162 g/mol, using polynom 3 fitness. |

TABLE 2
mNPN with Different Number Average Molecular
Weight Synthesized from the Above Process

| | | | | Polydis- | Average |
|---|---|---|---|---|---|
| | Mn (in | Mw (in | | persity | Hydroyl |
| | equivalent | equivalent | Average | index | number |
| | poly- | poly- | Function- | (PDI, | (mg |
| Hardener | styrene) | styrene) | ality | Mw/Mn) | KOH/g) |
| mNPN | 751 | 1056 | 5 | 1.41 | 175 |
| L-mNPN | 396 | 446 | 2.6 | 1.14 | 201 |

Synthesis of Naphthol Novolac Epoxy (e-mNPN)

All materials used in synthesizing naphthol novolacs were from Sinopharm Co. (Shanghai, China) except as mentioned otherwise.

150 ml of ethanol was added to a 500 ml three-necked bottle and 21 g NaOH was dissolved into the ethanol. The bottle was equipped with a stirrer, condenser and a tube for introduction of N₂. After the NaOH was completely dissolved, 300 ml (50% solids in toluene) of napathol novolac synthesized from the above process was added and stirred. The temperature was then increased to 80° C. to evaporate the ethanol. After ethanol was evaporated, 150 ml of epichlorohydrin was added slowly under 80° C. and the reaction was kept for 12 hours. After the reaction ended, the reaction mixture was poured into methanol and a large quantity of a red solid product was formed. The obtained crude resin was washed twice with methanol. Then washed with water and dried in the vacuum oven at 80° C.

Varnish Formulations

Ingredients

Epoxy e-mNPN (5 functionality epoxy, 60% in methyl ethyl ketone), from the above process

HP 4700 (4 functionality epoxy), from DIC Corporation

Epoxy L-e-mNPN (2.6 functionality epoxy), from the above process

Epoxy D.E.N. 438 (3.6 functionality epoxy, 60% in methyl ethyl ketone), from The Dow Chemical Company

eBPAN (Bisphenol A type phenolic novolac epoxy resin, EEW=200), from The Dow Chemical Company

mNPN (5 functionality naphthol novolac), synthesized compound from the above process

L-mNPN (2.6 functionality naphthol novolac), synthesized compound from the above process

2-DN (Bis(2-hydroxy-l-naphthyl)methane), from Sinopharm Co.(Shanghai, China)

X.Z. 92535 (phenol novolac resin 50% in Propylene Glycol Monomethyl Ether), from The Dow Chemical Company

Phosphorus compound of Formula 4 (60% in methyl ethyl ketone), from The Dow Chemical Company

HF-1M (phenol novolac resin, HEW=106), from Meiwa Plastic Company

MEH7000 (Cresol /Naphthol / Aldehyde type resin, HEW=143), from Meiwa Plastic Industries LTD

MEH7500 (triphenylmethane type phenol resin, HEW=97), from Meiwa Plastic Industries LTD

MEH7600-4H (high functionality phenol resin, HEW=100), from Meiwa Plastic Industries LTD

BPAN (Bisphenol A type phenolic novolac resin, HEW=125), from The Dow Chemical Company

2-methylimidazole (2-MI): curing catalyst (10% in Propylene Glycol Monomethyl Ether), from Sinopharm Chemical and Reagent Company

The above ingredients were mixed according to the corresponding formulation and shaken to form a uniform solution on a shaker. The catalyst was then added to the varnish, and gel time of the varnish was tested on a hot plate maintained at 171° C. The gelled material was recovered from the hot plate surface and post-cured in an oven at 220° C. for 2 h. Then the thermal properties of the cured material were measured by DSC and CTE was measured by TMA. The formulations and results are shown in Table 3.

TABLE 3
Varnish Formulations, Thermal Properties and CTE of Cured Epoxy Resins

| | Inv | Inv | Inv | Inv | Inv | Inv | Comp | Comp | Comp | Comp | Comp | Comp | Comp | Comp |
|---|---|---|---|---|---|---|---|---|---|---|---|---|---|---|
| | Ex 1 | Ex 2 | Ex 3 | Ex 4 | Ex 5 | Ex 6 | Ex A | Ex B | Ex C | Ex D | Ex E | Ex F | Ex G | Ex H |
| | solid | solid | solid | solid | solid | solid | solid | solid | solid | solid | solid | solid | solid | solid |
| Components | wt/g | wt/g | wt/g | wt/g | wt/g | wt/g | wt/g | wt/g | wt/g | wt/g | wt/g | wt/g | wt/g | wt/g |
| e-mNPN | 16.2 | 16.2 | | | | | | | | | | | | |
| L-e-mNPN | | | 36.4 | 36.4 | 35.1 | 33.3 | | | | | | | | |
| HP4700 | | | | | | | 10 | 10 | | | | | | |
| D.E.N. 438 | | | | | | | | | 13.8 | 16.6 | 19.7 | 18.6 | 18.9 | |
| eBPAN | | | | | | | | | | | | | | 15.4 |
| L-mNPN | 10 | | | | | | 10 | | | | | | | |
| 2-DN | | 10 | | | | | | 10 | | | | | | |
| MEH7000 | | | 10 | | | | | | 10 | | | | | 10 |
| MEH7500 | | | | 10 | | | | | | 10 | | | | |
| MEH7600- | | | | | 10 | | | | | | 10 | | | |
| 4H | | | | | | | | | | | | | | |
| HF-1M | | | | | | 10 | | | | | | 10 | | |
| X.Z.92535 | | | | | | | | | | | | | 10 | |
| (PN) | | | | | | | | | | | | | | |
| EEW/HEW | 1.1 | 1.1 | 1.1 | 1.1 | 1.1 | 1.1 | 1.1 | 1.1 | 1.1 | 1.1 | 1.1 | 1.1 | 1.1 | 1.1 |
| Gel time | 180 | 260 | 300 | 300 | 300 | 300 | 250 | 300 | 360 | 180 | 200 | 220 | 300 | 270 |
| (s, 2-MI as | | | | | | | | | | | | | | |
| catalyst) | | | | | | | | | | | | | | |
| Film Tg | 216 | 190 | 171 | 168 | 164 | 159 | 212 | 177 | 181 | 167 | 155 | 149 | 170 | 211 |
| (° C., DSC) | | | | | | | | | | | | | | |
| Film | 1.0 | 1.0 | 1.02 | 1.01 | 0.92 | 1.03 | 1.0 | 1.0 | 1.03 | 1.12 | 1.08 | 1.20 | 1.0 | 1.06 |
| Thickness | | | | | | | | | | | | | | |
| (mm) | | | | | | | | | | | | | | |
| Film α1 | 45 ± 2 | 45 ± 2 | 34 ± 2 | 42 ± 2 | 30 ± 2 | 49 ± 9 | 55 ± 2 | 54 ± 2 | 56 ± 2 | 61 ± 2 | 55 ± 2 | 53 ± 2 | 59 ± 2 | 63 ± 2 |
| (ppm/° C.) | | | | | | | | | | | | | | |
| (Z-axis CTE | | | | | | | | | | | | | | |
| 50~100° C., | | | | | | | | | | | | | | |
| TMA) | | | | | | | | | | | | | | |

The results in Table 3 show that the comparison between Inventive Example 1 and Comparative Example A, Inventive Example 2 and Comparative Example B, Inventive Examples 1 and 2 have an improved Tg and lower CTE although the epoxy resins were all naphthalene type. For the phenol novolac type hardener, Inventive examples 3-6 which used naphthol novolac epoxy resins showed improved CTE in comparison with Comparative examples C-H, which employed conventional high functional phenol type epoxy resins.

The type of phenolic resin hardener also influenced CTE performance. Comparing Inventive example 5, Inventive example 6 shows that using high functional triphenylmethane type hardeners results in lower CTE.

Properties of the Laminates

An inventive and three comparative laminates were prepared. The varnish formulations are listed in Table 4. First, the polymer ingredients were mixed to form a uniform 60% solution in MEK and shaken on the shaker for 1 hour. The varnish was then painted on the glass sheets (Hexcel 2116) and partially cured at 171° C. in a ventilated oven for a given time to make prepregs. Finally, 8 pieces of prepregs were hot pressed at 220° C. for two hours to make a laminate. Then the properties of the laminates were tested and detailed results are shown in Table 5.

TABLE 4
Varnish Formulations for the Laminates

| | | Inven- | Compar- | Compar- | Compar- |
|---|---|---|---|---|---|
| Compo- | | tive | ative | ative | ative |
| nent | | Ex. 7 | Ex. I | Ex. J | Ex. K |
| Epoxy | L-e-mNPN | 31.5 g | | | |
| | D.E.N. 438 | | 16.7 g | 18.1 g | 24.2 |
| Hardener | MEH7000 | 10 g | 10 g | 10 g | |
| | XZ 92535 | | | | 10 g |
| | (PN) | | | | |
| | DOPO-BN | 10.4 g | 6.7 g | 9.9 g | 12 g |
| EEW/HEW | | 1.1 | 1.1 | 1.1 | 1.1 |
| P wt. % | | 2.0 | 2.0 | 2.6 | 2.6 |

TABLE 5
Performance of Laminates

| 8 Layer | | | | | | | | | |
|---|---|---|---|---|---|---|---|---|---|
| board | | | | α1 (ppm/° C.) | | | Dₖ/D_{f} @ | Water | |
| #2116 | Tg by | Tg by | Td (° C.) | (Z-axis CTE, | Delamination | Cu peel | 1 GHz | absorption | |
| (laminate | DSC | DMTA | (5% WTL, | 50~100° C., | time | strength | (after water | (wt %) | US94 |
| thickness) | (° C.) | (° C.) | TGA) | TMA) | (T288, min) | (lb/in) | uptake) | (2 h) | V-0 |
| Inv. Ex 7 | 171 | 175 | 344 | 45 ± 5 | 40 | 6.47 | 3.95/0.016 | 0.36 | Pass |
| (1.16 mm) | | | | | | | | | |
| Comp. Ex I | 175 | 170 | 383 | 59 ± 5 | >60 | 9.29 | 3.98/0.020 | 0.50 | Fail |
| (1.44 mm) | | | | | | | | | |
| Comp. Ex J | 171 | 169 | 385 | 80 ± 5 | >60 | 8.75 | 3.51/0.016 | 0.71 | Pass |
| (1.29 mm) | | | | | | | | | |
| Comp. Ex K | 164 | 158 | 397 | 86 ± 5 | >60 | 8.70 | 3.91/0.023 | 0.81 | Pass |
| (1.28 mm) | | | | | | | | | |

The results in Table 4 show that compared with the control high functional epoxy resins, the Inventive example 7 shows a lower Z-axis CTE, lower water absorption and better flame retardant performance while almost retaining other properties such as Tg, heat resistance and dielectrical properties such as Dₖ and D_{f}. In addition, the laminate Tg can be effectively boosted by using e-mNPN with higher molecular weight.

### Testing Methods

The reactivity of the different varnish formulations was determined in terms of time required for the material to gel. The gel point is the point at which the resin turns from a viscous liquid to an elastomer. The gel time was measured and recorded using approximately 0.7 ml of liquid dispensed on a hot plate maintained at 171° C., stroking the liquid back and forth after 60 s on the hot-plate until it gelled.

Hand Lay-Up Technique

The hand lay-up technique was developed to make prepreg on a small scale quickly and easily. A single sheet of glass fabric approximately twelve inches square was stapled to a wood frame. The frame with e-glass fabric was placed on a flat surface that was covered with a disposable plastic sheet. About 25-35 grams of varnish was poured onto the e-glass fabrics and then evenly spread with a paint brush two inches in width. The frame with wetted glass fabrics was subsequently suspended in an air circulating oven at a temperature of 171° C. to remove solvent. After one minute, the frame was removed and allowed to cool to room temperature. The prepreg was crushed to obtain powder for further testing.

Thermogravity analysis (TGA) of the cured resins was performed with Instrument TGA Q5000 V3.10 Build 258. The test temperature ranges from room temperature to 600° C.; the heating rate is 20° C./min, nitrogen flow protection. The decomposition temperature (Td) was determined through selecting the corresponding temperature at 5% of weight loss (residual weight 95%) of materials.
Glass transition temperature (Tg) of the cured resins was determined by both DSC and DMTA.
The DSC testing condition was as follows:
N2 environment
Cycle one:
Initial Temp: room temperature
Final Temp: 180° C.
Ramp Rate=20° C./min
Cycle two:
Initial Temp: 180° C.
Final Temp: Room temperature
Ramp Rate=−20° C/min
Cycle three:
Initial Temp: 23° C.
Final Temp: 200° C.
Ramp Rate=10° C./min

DMTA Tg of the cured resins was determined with RSA III dynamic mechanical thermal analyzer (DMTA). Samples were heated from −50 to 250° C. at 3° C./min heating rate. Test frequency was 6.28 rad/s. The Tg of the cured epoxy resin was obtained from the tangent delta peak.

### CTE Test

Samples for CTE test were prepared and tested according to IPC-TM-650 2.4.41 by following steps:
1: Ramp 10.00° C./min to Tg;
2: Isothermal for 5.00 min;
3: Ramp 10.00° C./min to 30.00° C.;
4: Ramp 5.00° C./min to above Tg20° C.;
5: Jump to 30.00° C.

### UL94 Testing

The prepreg sheets were molded into a laminate and cured at 220° C. for 3 hrs by a regular hot press machine. The final laminate was cut into the standard samples for UL-94 FR testing. UL94 vertical flame testing was conducted in a CZF-2 vertical/horizontal burning tester made by Nanjing Jiangning Analytical Equipment Company. The chamber size was 720 mm×370 mm×500 mm, with natural gas as the burner gas resource. The chamber was opened during the whole testing process, with air flow around the testing device prohibited. Each specimen was ignited twice, with after flame time (AFT) tl and t2 recorded. AFT t1 and t2 were obtained as follows: The test flame was applied to the specimen for 10 seconds and then removed. The length of time (t1) was the duration between the flame removal and the time at which the flame on the specimen extinguished. Once the flame had extinguished, the test flame was applied for another 10 seconds and then removed. The duration of the burning of the specimen (t2) was again recorded.

### Water Uptake

Water uptake was performed by exposing 4 or 5 coupons in steam (121° C., 2 atm) for 1 hour in an autoclave. The coupon was removed and quickly baked, then weighed to determine the water uptake.

### Copper Peel Strength Test

Copper peel strength was tested by an IMASS SP-2000 Slip/Peel Tester according to the method described in IPC TM-650 2.4.8.1. The 35 μm standard copper foils were used for preparing laminates.

Dₖ and D_{f} Measurements

Samples were analyzed at room temperature with an Agilent 4991A Impendence/Material Analyzer equipped with Agilent 16453A test fixture. Calibration was done using an Agilent Teflon standard plaque using Dₖ/D_{f} parameters provided by vendor. Thickness of Teflon standard plaque and all samples was measured by micrometer.

### Clear Cast or Board Pressing Protocol:

a) Increase temperature to 220° C.

b) Exert force with 24000 Pounds at 220° C., repeat several times to exhaust bubbles

c) Keep constant pressure at 220° C. for 2 hrs

d) Cool down to room temperature

1. A composition comprising the structure of 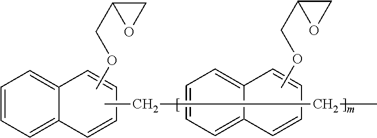
wherein m is an integer from 1 to 10.

2. A composition in accordance with claim 1 wherein the composition is a reaction product of
a) a naphthol which is a reaction product of
i) from 1 to 99 weight percent 1-naphthol and
ii) from 1 to 99 weight percent 2-naphthol; and
b) an epihalohydrin.

3. A curable composition comprising:
a) an epoxy component comprising the composition of claim 1
b) a hardener component comprising
i) a phenolic resin component selected from the group consisting of phenol novolac resins, triphenolalkane phenolic resins, aralkyl phenolic resins, biphenyl phenolic resin, biphenyl aralkyl phenolic resins, substituted naphthalene phenolic resins unsubstituted naphthalene phenolic resins, and combinations thereof; and
ii) a phosphorus-containing composition which is the reaction product of an etherified resole with 9,10-dihydro-9-oxa-10-phosphaphenanthrene-10-oxide.

4. The curable composition in accordance with claim 3 further comprising a filler selected from the group consisting of natural silica, fused silica, alumina, hydrated alumina, talc, alumina trihydrate, magnesium hydroxide and combinations thereof.

5. The curable composition in accordance with claim 3 wherein the phosphorus composition is DOP-BN.

6. The curable composition in accordance with claim 3 further comprising a catalyst.

7. The curable composition in accordance with claim 3 further comprising a toughener.

8. The curable composition in accordance with claim 3 wherein the epoxy component is present in an amount in the range of from 20 weight percent to 80 weight percent based on the total weight of the curable composition.

9. The curable composition in accordance with claim 4 wherein the filler is present in an amount in the range of from 10 weight percent to 80 weight percent.

10. The curable composition in accordance with claim 6 wherein the catalyst is present in an amount in the range of from 0.01 weight percent to 10 weight percent.

11. The curable composition in accordance with claim 7 wherein the toughener is present in an amount in the range of from 0.01 weight percent to 70 weight percent.

12. A process for preparing the curable composition of claim 3 comprising
a) contacting I) from 1 to 99 weight percent 1-naphthol; and
II) from 1 to 99 weight percent 2-naphthol;
in a reaction zone under reaction conditions to form a naphthol novolac composition;
b) contacting the naphthol novolac composition with an epihalohydrin in a reaction zone under reaction conditions to form an epoxidized naphthol novolac composition comprising the structure of 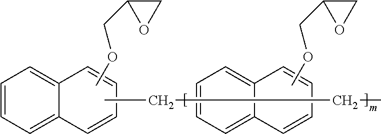
wherein m is an integer from 1 to 10; and
c) admixing i) the epoxidized naphthol novolac composition
ii) a phenolic resin curing agent comprising at least one substituted or unsubstituted naphthalene ring in a molecule; and
iii) an oligomeric compound comprising a phosphorus composition which is the reaction product of an etherified resole with 9,10-dihydro-9-oxa-10-phosphaphenanthrene-10-oxide.

13. A prepreg prepared from the curable composition of claim 3.

14. An electrical laminate prepared from the curable composition of claim 3.

15. A printed circuit board prepared from the electrical laminate of claim 3.

16. The curable composition in accordance with claim 3 wherein the resin is present in an amount in the range of from 1 weight percent to 60 weight percent based on the total weight of the curable composition.

17. The curable composition in accordance with claim 3 wherein the phosphorus-containing compound is present in an amount in the range of from 1 weight percent to 60 weight percent based on the total weight of the curable composition.

18. The prepreg of claim 13 wherein the prepreg comprises the curable composition of claim 3 and a reinforcement component.

19. The prepreg of claim 18 wherein the reinforcement component comprises a fiber, a fabric, or combinations thereof.

20. The electrical laminate of claim 14, wherein the electrical laminate comprises alternating layers of prepregs and a conductive material.
